(19) United States
(12) Patent Application Publication
(10) Pub. No.: US 2026/0253935 A1
(43) Pub. Date: Aug. 27, 2026

(54) ELECTROLYTE WETTING

(71) Applicant: FORD GLOBAL TECHNOLOGIES, LLC, Dearborn, MI (US)

(72) Inventors: Wilhelm Siebert, White Lake, MI (US); Ann Marie Straccia, Southgate, MI (US); Mikhail Trought, Dearborn, MI (US); Elham Honarvarfard, West Bloomfield, MI (US); Benjamin Jason Emley, Canton, MI (US); Yun Bai, Canton, MI (US)

(21) Appl. No.: 19/062,609

(22) Filed: Feb. 25, 2025

(51) Int. Cl. H01M 10/04

(52) U.S. Cl. CPC H01M 10/0404

(57) ABSTRACT

A battery manufacturing system applies a high-energy surface treatment to electrodes or separators before assembly. The treated electrodes are assembled into a dry battery, which is then filled with electrolyte to form a wet-out battery. A manufacturing control system, including one or more processors, applies potential and vibration to the wet-out battery to enhance electrolyte absorption and SEI layer formation. The system includes a frame that holds the pre-formation battery, contacts cell tabs, and may apply pressure. A transducer, either integrated into the frame or directly with a cell, induces vibration. The system supports various cell formats, including pouch, cylindrical, and prismatic cells.

### TECHNICAL FIELD

Various embodiments relate to a treated separator and a treated electrode and methods of producing the same.

### BACKGROUND

Electric vehicles include vehicles having an electric motor for vehicle propulsion, such as battery electric vehicles (BEV), hybrid electric vehicles (HEV), and plug-in hybrid electric vehicles (PHEV). A BEV includes an electric motor, wherein the energy source for the motor is a battery that is re-chargeable from an external electric grid. A HEV includes an internal combustion engine and an electric motor, wherein the energy source for the engine is fuel and the energy source for the motor is a battery. A PHEV is like a HEV, but the PHEV has a larger capacity battery that is rechargeable from the external electric grid.

Lithium-ion (Li-ion) batteries are used in BEVs, HEVs, and PHEVs due to their high voltage, high specific energy, high energy density, low self-discharge rate, long cycle life, and wide temperature operational range.

A separator is generally placed between an anode and a cathode of the Li-ion battery. The separator prevents physical contact of the two electrodes (e.g., internal short circuits), while still allowing for rapid transportation of ionic charge carriers between the cathode and anode.

### BRIEF DESCRIPTION OF THE DRAWINGS

FIG. 1 is a schematic of a battery cell.

FIG. 2 is a graphical illustration of increased surface etching with high-energy surface treatment.

FIGS. 3A and 3B are a magnified illustration of increased surface etching and associated elemental composition.

FIGS. 4A-4F illustrate electrolyte wetting after application of vibration and potential.

FIGS. 5 and 6 are example battery manufacturing systems.

FIGS. 7A-7C illustrate example frames retaining battery cells.

FIGS. 8A-8C illustrate example batteries with applied potential.

### SUMMARY

A manufacturing control system includes one or more processors programmed to simultaneously apply potential and vibration across the cells of a pre-formation battery after it has been filled with electrolyte. The system also comprises a frame designed to hold the pre-formation battery and contact the cell tabs. A transducer, arranged with the frame, is configured to induce vibration, and the frame itself is further designed to apply pressure to the cells. In some configurations, the frame includes a clamping plate, and the cells may be either pouch cells, cylindrical cells, or prismatic cells. Alternatively, a transducer may be arranged directly with one of the cells, such as an end cell of the pre-formation battery, to induce vibration. The processors are also programmed to apply a high-energy surface treatment to one or more electrodes or separators of the pre-formation battery before electrolyte filling. Additionally, the applied potential is less than 0.4 volts, while the vibration frequency exceeds 1,000 hertz.

A method comprises applying a high-energy surface treatment to electrodes, assembling the treated electrodes to form a dry battery, and filling the dry battery with electrolyte to create a wet-out battery. Once filled, potential and vibration are applied to the wet-out battery. In some implementations, the high-energy surface treatment is also applied to a separator before assembly. Additionally, pressure may be applied to the wet-out battery after electrolyte filling.

A battery manufacturing line includes a treatment station designed to apply a high-energy surface treatment to electrodes or separators, followed by a wetting station downstream that simultaneously applies potential and vibration to the treated electrodes and separators.

### DETAILED DESCRIPTION

Detailed embodiments are provided below. These embodiments, however, are intended solely as examples and may take various alternative forms and configurations. The accompanying figures are not drawn to scale. Certain features may be exaggerated, minimized, or omitted to highlight specific details of particular components. Consequently, the structural and functional details described herein are not to be interpreted as limiting but rather as illustrative examples to guide those skilled in the art in applying the described concepts in different ways.

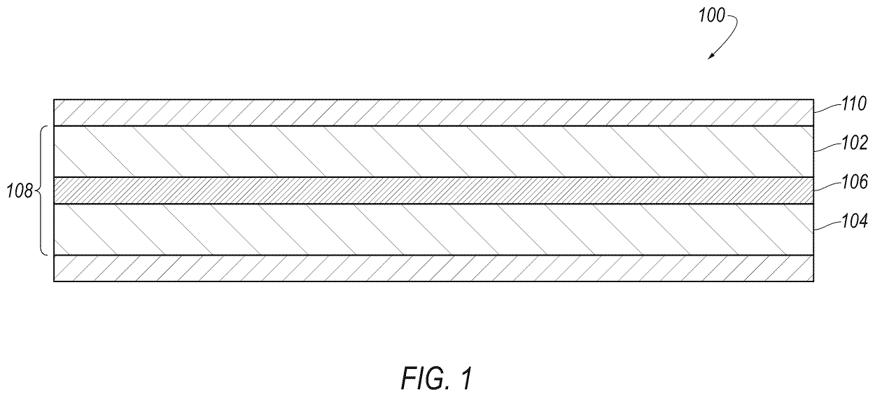

FIG. 1 illustrates a battery 100, which may be a secondary or rechargeable battery (e.g., a Li-ion battery). The battery 100 includes a negative electrode (anode) 102, a positive electrode (cathode) 104, a separator 106, and an electrolyte 108 disposed within the electrodes 102, 104 and separator 106. However, the battery 100 may include additional components or may not require all the components shown, depending on the battery type or configuration. In addition, a current collector 110 may be disposed on one or both of the anode 102 and cathode 104. In at least one embodiment, the current collector 110 is a metal or metal foil. In one embodiment, the current collector 110 is formed of aluminum or copper. Examples of other suitable metal foils may include, but are not limited to, stainless steel, nickel, gold, or titanium.

Li-ion battery anodes may be formed of carbonaceous materials, such as graphite (natural, artificial, or surface-modified natural), hard carbon, soft carbon, or Si/Sn-enriched graphite. Non-carbonaceous anodes may also be used, such as lithium titanate oxide (LTO), silicon and silicon composites, lithium metal, and nickel oxide (NiO). Li-ion battery cathodes may include lithium nickel cobalt aluminum oxide (NCA), lithium nickel manganese cobalt oxide (NMC), lithium manganese spinel oxide (Mn Spinel or LMO), lithium iron phosphate (LFP) and its derivative lithium mixed metal phosphate (LFMP), and sulfur or sulfur-based materials (e.g., sulfur-carbon composites). In addition, mixtures of any of two or more of these materials may be used. These electrode materials are merely examples. Any electrode materials known in the art may be used.

Li-ion batteries generally include a liquid electrolyte, which may include a lithium salt and an organic solvent. Suitable organic solvents may include ethylene carbonate (EC), dimethyl carbonate (DMC), ethyl methyl carbonate (EMC), diethyl carbonate (DEC), or mixtures thereof. Li-ion battery separators may be formed of any suitable ionically conductive, electrically insulating material, for example, a polyolefin (e.g., polyethylene or polypropylene).

Electrode production may include casting a slurry onto the current collector 110 and drying the slurry to form the electrode 102 and/or 104. The slurry may include active material, conductive material, binder, and/or solvent. The composite slurry may be spread evenly onto the current collector 110 during casting to facilitate a uniform electrode. If the integrity of the electrode-current collector interface is affected through repeated cycling and swelling, the interfacial resistance may increase and portions of the active materials may become isolated, leading to capacity fade. Other methods for adhesion of the composite electrode to the current collector surface are needed. One of the issues in developing a high performance cell is ensuring a strong and long-lasting bond between the current collector 110 and the composite electrode layer that is applied to it.

One process step in battery cell manufacturing is the electrolyte wetting of the electrodes and separator after electrolyte filling. Wetting is the diffusion of the electrolyte over the electrodes and separators. Inhomogeneous or partial wet-out in the cell will result in “dry” areas that can lead to improper solid electrolyte interphase (SEI) layer formation, local increased impedance, lower cell performance, heat generation, and lithium plating.

The wetting of the cell with electrolyte can be a time-consuming process. Wetting time may be decreased by, for example, modifying the chemistry of the electrolyte. This typically would involve engineering a material with additives into a substrate or using a different binder with hydrophilic groups to affect the wetting behavior. A favorable system for optimal wetting may be a high surface energy substrate with a contact wetting liquid at a similar surface tension. Additives can be used to change the surface energy of a substrate or the surface tension of a liquid. The addition of additives to an electrode slurry in order to increase the top surface energy after drying would rely on the mechanism of migration. This approach can be difficult to control in manufacturing since the drying rate will affect the migration of additives. There could be competing interactions with the binder or other constituents in the slurry due to slight changes of the drying conditions. These processing concerns could also be true for different binders with hydrophilic groups. Most polymer surfaces will typically maintain a certain level of hydrophobicity based on its bulk chemistry. The other concern with changing bulk chemistry of the system is that it could have a significant effect on battery electrode properties, performance, and durability.

Process parameters can have influence on the resulting surface energy of a substrate. The drying rate of solvent based slurry can influence the binder migration during the drying process. This in turn can lead to a higher amount of binder on the surface which can increase hydrophobicity on that surface. During binder migration, different surfaces can form under different mixing and drying conditions. Therefore, processing conditions such as mixing and drying conditions can affect surface chemistry.

Furthermore, in addition to electrode surfaces, electrolyte also is absorbed into the electrode. The process of absorption is governed by the physical microstructure. Once the electrolyte penetrates the surface, it has to fill the pores inside it. Sufficient contact by the electrolyte between electrode particles is crucial for an optimal ionic conductivity in the cell and in turn can lead to high-capacity retention for high current applications. Different degrees of calendaring and resulting porosity and pore diameters have an influence on the wetting rate into the electrode. The wetting rate depends on the degree of compression (e.g., to increase density) induced by the calendaring process. Denser cells experience greater capillary flow and a reduced wetting rate.

As mentioned above, the surface chemistry and porosity of an electrode influences the time required for the process of electrolyte wetting. Described herein are embodiments relating to a combination of high-energy surface treatment, electrochemical capillary and high frequency assisted wetting, and the processing steps, parameters, and equipment to achieve optimal electrolyte wetting in state-of-the-art cells, which are format type (e.g., cylindrical, prismatic, pouch, or others) and chemistry independent (e.g., solvent based or dry coated, solid or semisolid state battery chemistries).

Data (e.g., x-ray photoelectron spectroscopy (XPS), atomic force microscopy (AFM), and pycnometer data) has shown that a high-energy surface treatment can speed the absorption of electrolyte (e.g., 1.2M lithium hexafluorophosphate (LiPF6) in 30/70 EC/DMC) more than sevenfold on anodes (e.g., made from artificial and natural graphite, carboxymethyl cellulose (CMC), and styrene-butadiene rubber (SBR)) when treated at production rates of 300 mm/s. In addition to the faster absorption rate, data has indicated that the electrolyte also spreads more evenly over the surface compared to untreated surfaces. The increased absorption rate can be quantified in units of μl/min. As an example, a high-energy surface treatment can increase the absorption rate from less than 0.8 μl/min to 6.25 μl/min. These values are determined by introducing 25 μl of electrolyte to both an untreated substrate and a treated substrate.

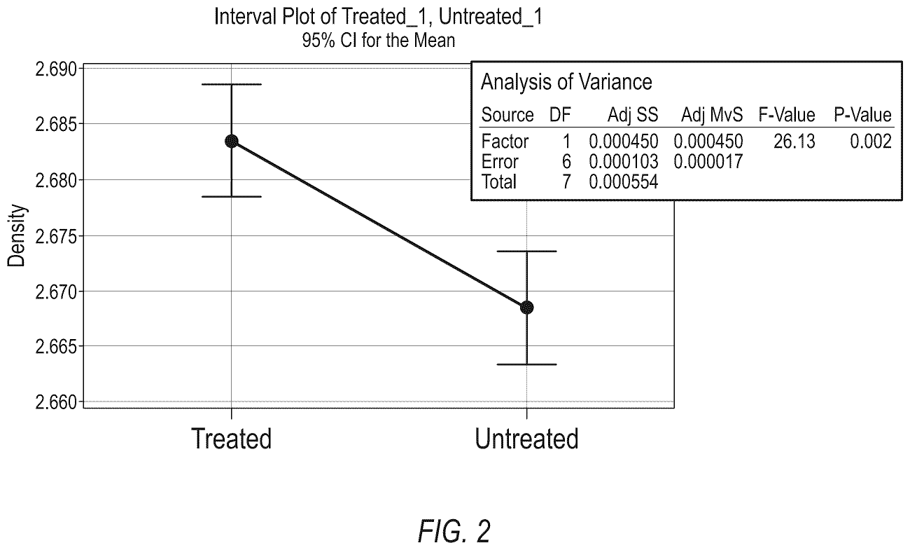

FIG. 2 is a graphical illustration of the increase in electrode density as measured by a pycnometer between electrodes subjected to a high-energy surface treatment and those not subjected to a high-energy surface treatment. High-energy treatments of surfaces may include application of gasses or temperatures. For example, an atmospheric pressure air plasma (APAP) process may be used in order to affect the rate and extent of electrolyte wetting and modify the surface properties of the membrane. The air plasma treatment modifies the surface properties of the membrane and operates at a low temperature such that the membrane pore structure remains intact after treatment. APAP alters the surface of the plastic component in preparation for a coating but does not require the use of a low pressure chamber. The altered surface of the membrane results from the formation of a functionalized polymer layer during the plasma treatment. Other examples of high-energy surface treatments may include corona treatment, flame application, etc.

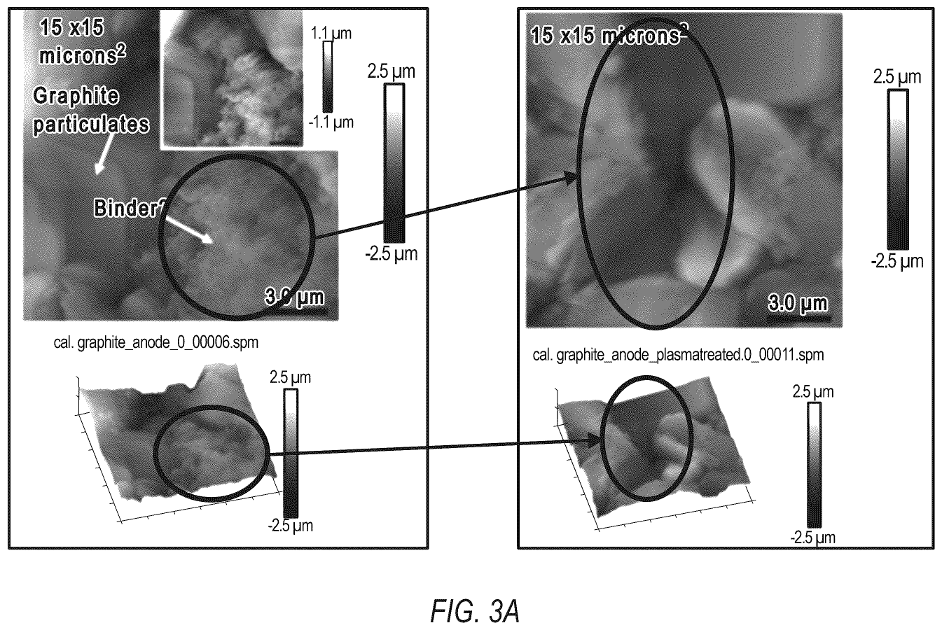

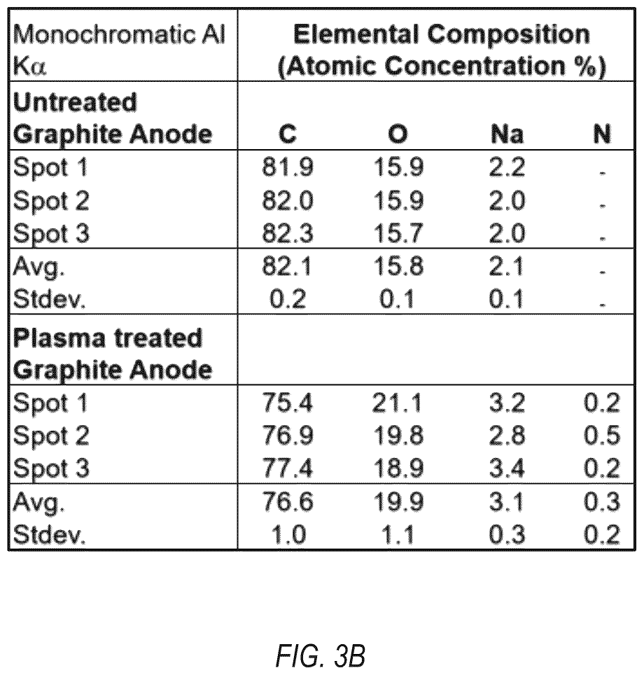

FIGS. 3A and 3B is an illustration of increased surface etching in electrodes as a result of high-energy surface treatment along with the elemental composition of the surface respectively. The increased surface etching may align with data indicating reduced carbon and higher sodium amounts on the surface of treated electrode samples. The sodium is associated with the CMC as may be determined through XPS analysis of the raw material. The higher level of sodium is an indication of the removal of a more carbon dense material revealing more CMC at the surface. Additionally, high-energy treatment may add more oxygen to the surface which may result in the surface being more chemically active and therefore more hydrophilic.

Additional experiments have shown similar behavior on cathode material as described above with respect to anode material. However, data has indicated lower absorption rates found for anode material (6.25 μl/min). The rate increase for cathode material was doubled from 0.625 μl/min to 1.25μl/min using high-energy surface treatment at production intended speeds of 300 mm/s. Additionally, a more homogeneous spreading of the electrolyte across the available surface was achieved in testing for both anode and cathode material as a result of high-energy treatment. This shows that surface treatment alone increases wetting but could be further complimented by additional mechanisms to drive wetting time down further.

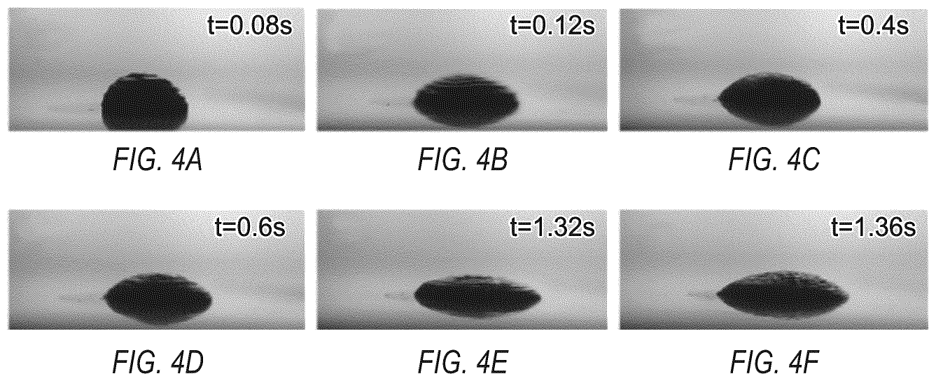

FIGS. 4A-F illustrate electrolyte wetting as a result of high frequency assisted wetting. As an example, high frequency assisted wetting may include vibration of cells containing the electrode material and separator material. The specific frequency may be predetermined. In one embodiment, the frequency of vibration may be greater than 1,000 Hz. High frequency assisted wetting, in parallel with an electrocapillary processes, further increases the speed of electrolyte saturating the cell between all layers (e.g., separator/electrode). Additionally, the combination of high frequency assisted wetting and electrocapillary action may also enable saturation through the pore and channels inside the densely calendared coating. By introducing high frequency vibration to a closed battery cell, the vibration induced momentum transfer at the solid-liquid interface can be a driving force by reducing the interface contact angle as shown, as time t increases while a high frequency vibration is applied to the surface on which electrolyte is disposed, the electrolyte is dispersed over a wider area of the surface, thereby decreasing the contact angle between the surface and the electrolyte.

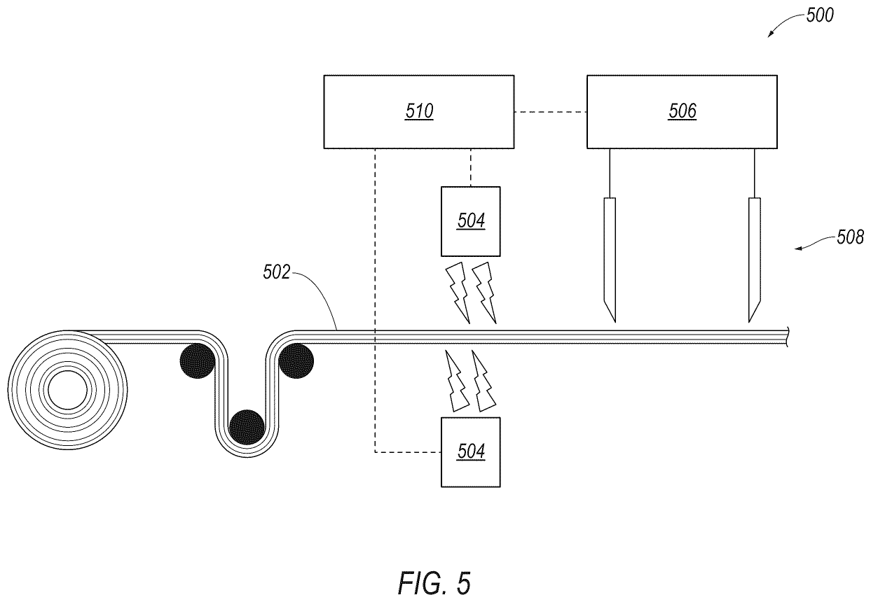

FIG. 5 illustrates an example manufacturing control system 500 for applying a high-energy surface treatment to electrode materials and separator materials 502. The material can be in the form of a web, a single sheet, or a stack of sheets in any configuration. If the material is presented to the system 500 in the form of a web, a high-energy treatment source 504 (e.g., a plasma applicator) is placed above and below the web in a manner to achieve optimal treatment of both surfaces. The treatment of web material would apply to cylindrical and prismatic cells, as they are primarily wound. This system also could be applied to a pouch cell format, in case the notching process is integrated into the stacking equipment, as the high-energy surface treatment needs to happen just before the cell assembly. In the present example, the system 500 includes a notching assembly 508 positioned downstream of the high-energy treatment source 504. The notching assembly 508 is configured to divide the material 502 into predetermined lengths. The notching assembly 508 is actuated by a notching controller 506 which is in communication with a processor 510 (e.g., a computer, controller, etc.)

The processor 510 includes a memory that stores instructions executable to carry out various processes and operations, including those described herein. This memory comprises one or more forms of computer-readable media and contains instructions that enable the processor 510 to perform a range of operations. Additionally, the processor 510 may communicate with submodules responsible for actuating components along a battery manufacturing line, such as the system 500.

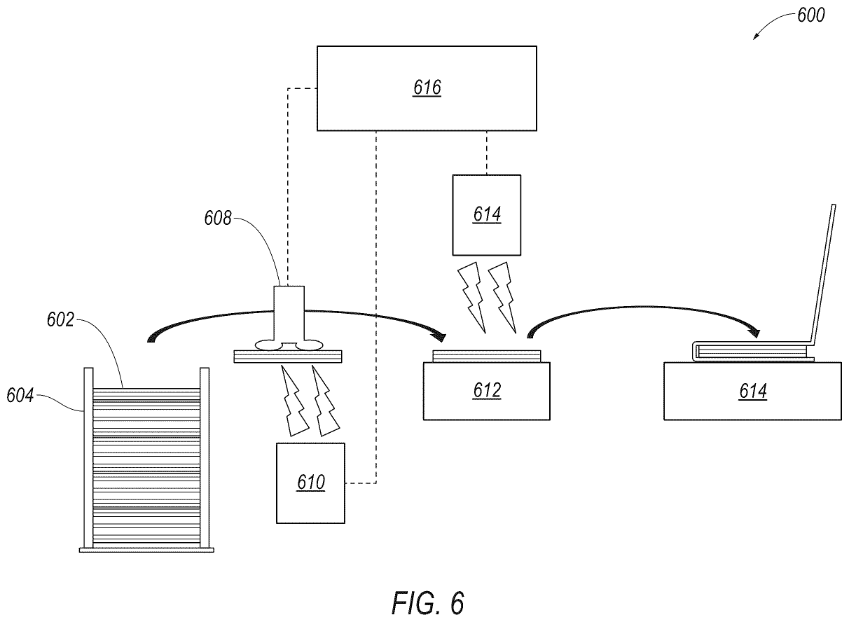

FIG. 6 illustrates an example manufacturing control system 600 for applying a high-energy surface treatment to electrode and separator materials where the materials are intended for assembly into pouch cells. Pouch cells may have the notching and stacking process separated by a step of vacuum drying. In such a scenario, the high-energy surface treatment is applied during transfer of a sheet 602 from a magazine 604 to a stacking unit 606. A pick-and-place unit 608 may move the sheet 602 over a high-energy surface treatment applicator 610 and place the sheet 602 on an intermediate table 612. A second high-energy surface treatment applicator 614 may be positioned over the intermediate table 612 such that the opposite side of the sheet 602 receives the high-energy surface treatment. The pick-and-place unit 608 may then move the sheet 602 from the intermediate table 612 to a stacking table 614 for stacking into the stacking unit 606. The pick-and-place unit 608 and the high-energy treatment applicators 610, 614 may be in communication with a processor 616 and configured to received actuation commands from the processor 616.

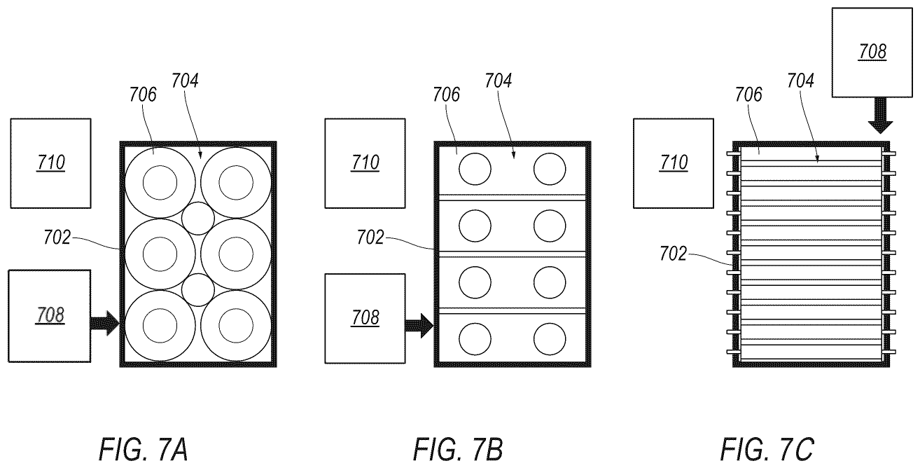

FIGS. 7A-C illustrate example frames 702 for retaining a pre-formation battery 704. Pre-formation as used herein means prior to completion of electrolyte drying. The battery 704 includes the cells 706 pre-formation (e.g., prior to the electrolyte fully drying). After electrolyte filling, the cell 706 is closed and moved into the wet-out area of the manufacturing process. At this stage, the cells 706 are disposed within the frame 702. The frame is configured to transmit the high frequency vibration to the cells 706 as well as allow an electric potential to be applied to the cells. The apparatus may clamp/hold the cells 706 in a way to contact tabs of the cells 706 (FIG. 7c). The frame 702 may be further configured to apply a specified pressure on pouch cells 706 (FIG. 7C), while cylindrical/prismatic cells need only be in contact with the frame 702. The frame 702 may include a high frequency transducer 708 configured to vibrate the cells 706 at a high frequency under the control of processor 710. As another example, the high frequency transducer may be a separate component from the frame 702. In such an example the high frequency transducer 708 may be actuated to contact one or more of the cells 706. The location for the transducer 708 may be cell type dependent. That is, for cylindrical and prismatic cells, the transducer 708 may be disposed such that it contacts the top or bottom of the cells. For pouch cells, the vibration can be transmitted via frame 702 on each side of the cell.

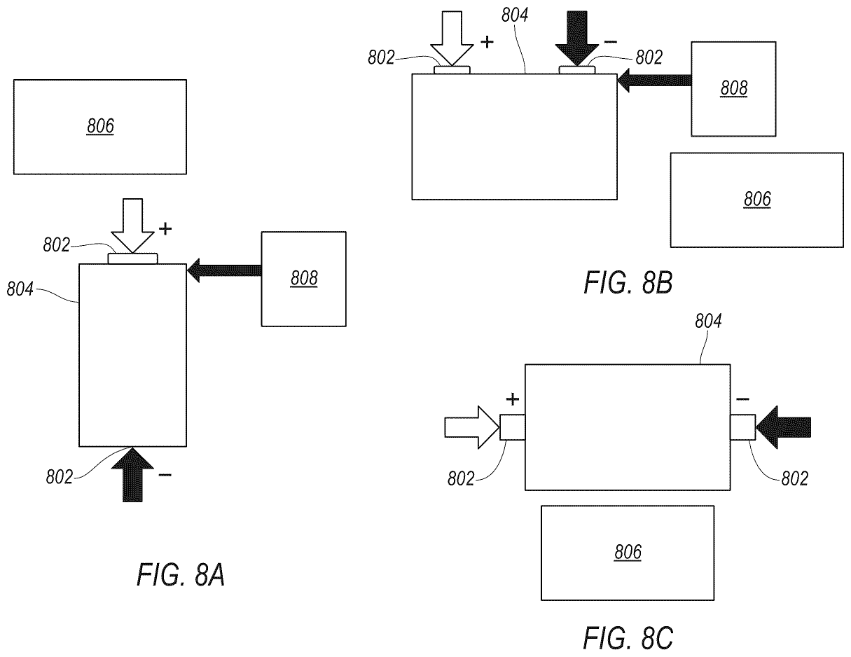

FIGS. 8A-C illustrate example contactors 802 positioned on cells 804 such that the cells 804 receive an electric potential. The cells 804 receive a micro-voltage via the contactors 802 based on the cell chemistry. As an example, the voltage may be less than 0.4 volts. The voltage may be supplied by any suitable power source. A processor 806 may actuate the power source to supply the potential to the cell 804. Furthermore, the processor 806 may actuate the power source to supply the potential to the cell 806 simultaneously with actuating a transducer 808 to vibrate the cell 804. The potential is applied over the course of a chemistry specific wetting time and is also dependent on the size of the cell (e.g., a larger cell may require a longer cycle time).

Any of the above-mentioned mechanisms in combination and their chemistry-dependent processing parameters is useable, but not required in any specific combination. Certain chemistries or cell designs may warrant one or more of these mechanisms in combination and are therefore not excluded or exempt. The electrolyte can be liquid such as the LiFP₆ electrolyte outlined in the experiments but could also be gel-like (higher viscosity) electrolyte in case of semi-solid state batteries.

The systems and processes described above allow for a reduction in electrolyte wetting time, homogeneous and consistent electrolyte saturation level in the pores of the electrode, and reduction of formation and ageing processing time.

Computing devices such as those discussed herein generally each include commands executable by one or more computing devices such as those identified above, and for carrying out blocks or steps of processes described above. For example, processes discussed above may be embodied as computer executable commands.

Computer executable commands may be compiled or interpreted from computer programs created using a variety of programming languages and/or technologies, including, without limitation, and either alone or in combination, Java™, C, C++, Python, Julia, SCALA, Visual Basic, Java Script, Perl, HTML, etc. In general, a processor (e.g., a microprocessor) receives commands (from a memory, a computer readable medium, etc.) and executes these commands, thereby performing one or more processes, including one or more of the processes described herein. Such commands and other data may be stored in files and transmitted using a variety of computer readable media. A file in a computing device is generally a collection of data stored on a computer readable medium, such as a storage medium, a random access memory, etc.

A computer-readable medium (also referred to as a processor-readable medium) includes any non-transitory (i.e., tangible) medium that participates in providing data (i.e., instructions) that may be read by a computer. Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, PROM, EPROM, FLASH-EEPROM, any other memory chip or cartridge, or any other medium from which a computer can read.

With regard to the media, processes, systems, methods, etc. described herein, although the steps or blocks of such processes, etc. may have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments and should in no way be construed so as to limit the claimed invention.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the claimed invention.

What is claimed is:

1. A manufacturing control system comprising:
one or more processors programmed to, at a same time, apply potential and vibration across cells of a pre-formation battery after the pre-formation battery has been filled with electrolyte.

2. The system of claim 1 further comprising a frame configured to hold the pre-formation battery and to contact tabs of the cells.

3. The system of claim 2 further comprising a transducer arranged with the frame and configured to induce the vibration.

4. The system of claim 2, wherein the frame is further configured to apply pressure to the cells.

5. The system of claim 4, wherein the frame includes a clamping plate.

6. The system of claim 4, wherein the cells are pouch cells.

7. The system of claim 2, wherein the cells are cylindrical cells or prismatic cells.

8. The system of claim 1 further comprising a transducer arranged with one of the cells and configured to induce the vibration.

9. The system of claim 8, wherein the one of the cells is an end cell of the pre-formation battery.

10. The system of claim 1, wherein the one or more processors are further programmed to apply a high-energy surface treatment to one or more electrodes of the pre-formation battery before the pre-formation battery has been filled with electrolyte.

11. The system of claim 1, wherein the one or more processors are further programmed to apply a high-energy surface treatment to one or more separators of the pre-formation battery before the pre-formation battery has been filled with electrolyte.

12. The system of claim 1, wherein the potential is less than 0.4 volts.

13. The system of claim 1, wherein the vibration has a frequency greater than 1,000 hertz.

14. A method comprising:
applying a high-energy surface treatment to electrodes;
assembling the electrodes to form a dry battery;
filling the dry battery with electrolyte to form a wet-out battery; and
applying potential and vibration to the wet-out battery at a same time.

15. The method of claim 14 further comprising applying the high-energy surface treatment to a separator before the assembling.

16. The method of claim 14 further comprising applying pressure to the wet-out battery after the filling.

17. The method of claim 14, wherein the potential is less than 0.4 volts.

18. The method of claim 14, wherein the vibration has a frequency greater than 1,000 hertz.

19. A battery manufacturing line comprising:
a treatment station configured to apply a high-energy surface treatment to electrodes or separators; and
a wetting station downstream of the treatment station and configured to apply potential and vibration to the electrodes and separators at a same time.

20. The line of claim 19, wherein the potential is less than 0.4 volts and the vibration has a frequency greater than 1,000 hertz.
